(19) United States
(12) Patent Application Publication
(10) Pub. No.: US 2024/0283743 A1
(43) Pub. Date: Aug. 22, 2024

(54) DETERMINISTIC DATA TRANSMISSION DEVICE AND METHOD FOR COMPATIBILITY NETWORK

(71) Applicant: ZHEJIANG LAB, Hangzhou (CN)

(72) Inventor: Xuyang ZHAO, Hangzhou (CN)

(21) Appl. No.: 18/024,750

(22) PCT Filed: Dec. 1, 2022
(86) PCT No.: PCT/CN2022/135889

§ 371 Date: Mar. 4, 2023

(30) Foreign Application Priority Data
Apr. 13, 2022 (CN) 202210381729.2

(51) Int. Cl. H04L 47/24

(52) U.S. Cl. CPC H04L 47/245

(57) ABSTRACT

The present disclosure relates to a deterministic data transmission device and method for a compatibility network. The device includes a data link layer and a physical layer of an open system interconnection. The data link layer includes a support module of preemption function of a MAC client, a MAC control module, and a MAC merge module, and the physical layer includes a coordination sublayer and a port physical layer. And the support module of preemption function of the MAC client is connected to the MAC control module, the MAC merge module is connected to the coordination sublayer, and the port physical layer includes a physical transport medium connected to the coordination sublayer. The deterministic data transmission method for a compatibility network includes slicing of low priority data, enveloping low priority frames, combining sliced frames, and verifying a combination of sliced frames.

### CROSS-REFERENCE TO RELATED APPLICATIONS

This application is a U.S. national phase application under 35 U.S.C. § 371 base upon international patent application No. PCT/CN2022/135889, filed on Dec. 1, 2022, titled “DETERMINISTIC DATA TRANSMISSION DEVICE AND METHOD FOR COMPATIBILITY NETWORK”, which itself claims all benefits accruing from China Patent Application No. 202210381729.2, filed on April 13, 2022, titled “DETERMINISTIC DATA TRANSMISSION DEVICE AND METHOD FOR COMPATIBILITY NETWORK” in the China National Intellectual Property Administration, both of which are hereby incorporated by reference.

### TECHNICAL FIELD

The present disclosure relates to the field of deterministic low-latency transmission of data, and in particular, to a deterministic data transmission device and method for a compatibility network.

### BACKGROUND

With the development of Industry 4.0, a goal of intelligent manufacturing is to lead a development of next generation industrial technology, and industrial internet is on an increasingly larger scale. A cyber physical system is primarily computer-controlled, and more and more sensors and actuators are integrated into the system. In the cyber physical system, motion control of collaborative robots has high time sensitivity. In order to ensure deterministic behaviors of the cyber physical system under control, it is necessary to offer a real-time communication network with a deterministic bounded network delay and delay change, so as to meet control needs of devices and improve production efficiency of the devices. With a development of Ethernet technology, decoupling between devices is caused by PROFINET, CC-Link and other real-time technologies, and transmission delay of data is basically maintained at a microsecond level. The transmission delay of data can reach a nanosecond level via optimization of a preemptive technology.

In order to schedule in real time in the system, interference on high priority traffic must be prevented, otherwise delay of a bus in the system will be increased, and transmission variation will be increased. A time aware shaper can block non-scheduled traffic, but for jumbo frames in the network, a conventional preemption technology still results in a high delay and cannot meet a deterministic transmission requirement of the high priority traffic.

### SUMMARY

According to various embodiments of the present disclosure, a deterministic data transmission device for a compatibility network is provided. The device includes a data link layer and a physical layer of an open system interconnection. The data link layer includes a support module of preemption function of a MAC (Media Access Control) client, a MAC control module, and a MAC merge module, and the physical layer includes a coordination sublayer and a port physical layer. And the support module of preemption function of the MAC client is connected to the MAC control module, the MAC merge module is connected to the coordination sublayer, and the port physical layer includes a physical transport medium connected to the coordination sublayer.

In some embodiments, when data is sent, the data link layer is configured to identify the preemption function of the MAC client, and the MAC control module is configured to allocate high real-time demand data and non-real-time demand data to two channels, respectively, and transmit high real-time demand data and non-real-time demand data via the physical layer.

When data is received, the physical layer is configured to transmit the data to the data link layer, the MAC merge module of the data link layer is configured to identify preempted data and merge the preempted data, and the MAC control module is configured to allocate high real-time demand data and non-real-time demand data of merged data to a higher-level open system interconnection, respectively.

In some embodiments, the support module of preemption function of the MAC client is configured to identify whether a data slicing function of a local port is turned on.

If yes, it indicates that a transmission of high priority data is supported to interrupt a transmission of low priority data, the transmission of the low priority data is suspended, and the low priority data is sliced to wait for the transmission of the high priority data to be completed and then continue transmission. If no, it indicates that a transmission of sliced data is not supported and a data transmission is performed according to QoS (Quality of Service) mechanism.

In some embodiments, the MAC merge module is configured to reorganize received sliced data with the support of the preemption function, and to recover data at a receiving port for the low priority data, a transmission of which is interrupted.

In some embodiments, the MAC control module is connected to the MAC merge module, and the MAC control module includes a pMAC channel and an eMAC channel, high priority data is transmitted in the eMAC channel, data that is capable to be preempted is transmitted in the pMAC channel, and data without priority order requirements is transmitted in the pMAC channel or the eMAC channel.

The present disclosure further provides a deterministic data transmission method for a compatibility network, including slicing of low priority data, enveloping low priority frames, combining sliced frames, and verifying a combination of sliced frames. In the slicing of low priority data, a transmitting device slicing low priority data into a first frame, a plurality of intermediate frames, and a tail frame. In the enveloping low priority frames, keeping the first frame in the same frame format as an unsliced low priority frame, the transmitting device applying MCRC (Middle Cyclic Redundancy Checksum) in frame preemption instead of CRC as a checksum with 4 bytes in a tail, introducing a preamble in the plurality of intermediate frames and the tail frame after slicing, not introducing a destination address or an Ethernet type segment in the plurality of intermediate frames and the tail frame, and filling a sliced frame type in a byte after the preamble to mark as a certain subsequent frame of a slice. In the combining sliced frames and the verifying the combination of sliced frames, for different low priority sliced first frames, a receiving device determining correctness of the low priority sliced first frames via the byte after the preamble, and for different low priority sliced intermediate frames and tail frames, the receiving device determining whether adjacent low priority slices arrive correctly and in order via the byte after the preamble.

In some embodiments, a second byte after the preamble of the plurality of intermediate frames and the tail frame includes a slice counter segment.

In some embodiments, the method further includes modifying one or two segments after the preamble of the first frame, the plurality of intermediate frames, and the tail frame in the frame preemption, and the segments include a SMD (Start mPacket Delimiter) segment and a MCRC segment. SMD-Sx and SMD-Cx are applied to the first frame and subsequent frames in low priority frames, respectively, and the SMD-Sx and SMD-Cx provide 3 different values for slice counting, respectively.

In some embodiments, the receiving device recording a slice counting value of the last received frame to compare with that of a received frame next time, the receiving device determining that the frame was transmitted in error after the received frame does not meet consecutive slice counting, thereby discarding the received frame, and the receiving device discarding slices that have been buffered and slices that have not yet been received.

In some embodiments, MCRC is introduced into tails of the plurality of intermediate frames, and the MCRC is configured to check frame bytes of sliced data frames.

The details of one or more embodiments of the present disclosure are set forth in the accompanying drawings and the description below. so that other features, objects and advantages of the present disclosure will become more concise and understandable.

### BRIEF DESCRIPTION OF THE DRAWINGS

To describe and illustrate embodiments and/or examples of the present disclosure made public here better, reference may be made to one or more of the figures. The additional details or embodiments used to describe the figures should not be construed as limiting the scope of any of the present disclosure, the embodiments and/or examples currently described, and the best model of the present disclosure as currently understood.

FIG. 1 is a schematic view of a deterministic data transmission device for a compatibility network in some embodiments of the present disclosure.

FIG. 2 is a schematic view of frame preemption in some embodiments of the present disclosure.

FIG. 3 is a schematic view of a byte format of an Ethernet frame in some embodiments of the present disclosure.

FIG. 4 is a schematic view of slicing an Ethernet frame in some embodiments of the present disclosure.

### DETAILED DESCRIPTION

To make purposes, technical solutions and advantages of the present disclosure clearer, the present disclosure is described and explained below with reference to the accompanying drawings and embodiments of the present disclosure. It should be understood that the specific embodiments described herein are only used to interpret the present disclosure and are not intended to limit the present disclosure. Based on the embodiments provided in the present disclosure, all other embodiments obtained by those of ordinary skill in the art without performing creative work fall within the scope of the present disclosure. Furthermore, it is also understood that although the efforts made in development process may be complex and lengthy, for ordinary persons skilled in the art related to the content disclosed in the present disclosure, some design, manufacturing or production variations based on the technical content disclosed in the present disclosure are only conventional technical means, and should not be understood as insufficient content disclosed in the present disclosure.

References to “embodiment” in the present application means that a particular feature, structure or property described in conjunction with the embodiment may be included in at least one embodiment of the present application. The occurrence of the phrase in various positions of the description does not necessarily refer to the same embodiment, nor is it a separate or alternative embodiment that is mutually exclusive with other embodiments. Those of ordinary skill in the art expressly and implicitly understand that the embodiments described in the present application may be combined with other embodiments without conflict.

Unless otherwise defined, all technical and scientific terms used herein have the same meaning as one skilled in the art would understand. The term “one”, “a”, “an”, “the” and other similar words as used in the present invention do not indicate quantitative limitations, and they can be singular or plural. The term “plurality” in the present disclosure refers to two or more. The terms “include”, “comprise”, “have”, and any variation thereof, as used in the present invention, are intended to cover a non-exclusive inclusion.

The technical solutions in the embodiments of the present disclosure are clearly and completely described in the following with reference to the accompanying drawings in the embodiments of the present disclosure. It is obvious that the described embodiments are only a part of the embodiments, but not all of the embodiments.

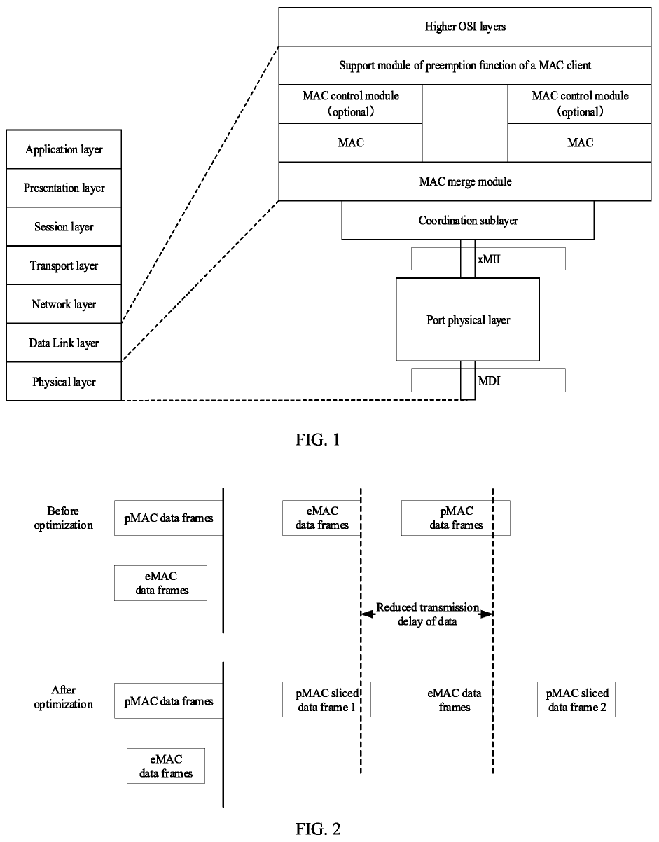

Referring to FIG. 1, a deterministic data transmission device for a compatibility network includes a data link layer and a physical layer of an OSI (Open System Interconnection). The data link layer includes a support module of preemption function of a MAC (Media Access Control) client, a MAC control module, and a MAC merge module. The physical layer includes a coordination sublayer and a PHY (Port Physical Layer). The support module of preemption function of the MAC client is connected to the MAC control module, the MAC merge module is connected to the coordination sublayer, and the PHY includes a physical transport medium connected to the coordination sublayer.

When data is sent, the data link layer is configured to identify the preemption function of the MAC client, and the MAC control module is configured to allocate high real-time demand data and non-real-time demand data to two channels, respectively, and transmit high real-time demand data and non-real-time demand data via the physical layer.

When data is received, the physical layer is configured to transmit the data to the data link layer, the MAC merge module of the data link layer is configured to identify preempted data and merge the preempted data, and the MAC control module is configured to allocate high real-time demand data and non-real-time demand data of merged data to a higher-level open system interconnection, respectively.

The data transmitted to the data link layer can be divided into high priority data and low priority data. The high priority data can preempt the low priority data, and a transmission of the high priority data can interrupt a transmission of the low priority data. The low priority data can be sliced into a plurality of data frames (i.c., preempted data frames). At this moment, the data frames after transmission need to be merged to restore to a data format of the data link layer. The above process can be divided into data transmission—data preemption—data merging—data recovery.

The support module of preemption function of the MAC client can be configured to identify whether a data slicing function of a local port is turned on. If yes, it indicates that the transmission of the high priority data can be supported to interrupt the transmission of the low priority data, the transmission of the low priority data can be suspended, and the low priority data can be sliced to wait for the transmission of the high priority data to be completed and then continue transmission. If no, it indicates that a transmission of sliced data is not supported and a data transmission is performed according to QoS (Quality of Service) mechanism.

The MAC merge module can be configured to reorganize received sliced data with the support of the preemption function, and to recover data at a receiving port for the low priority data, the transmission of which is interrupted.

The MAC control module can be connected to the MAC merge module, and the MAC control module can include a pMAC channel and an eMAC channel. The high priority data can be transmitted in the eMAC channel, data that is capable to be preempted can be transmitted in the pMAC channel, and data without priority order requirements can be transmitted in the pMAC channel or the eMAC channel.

A deterministic data transmission method for a compatibility network can include slicing of low priority data, enveloping low priority frames, combining sliced frames, and verifying a combination of sliced frames.

In the slicing of low priority data, a transmitting device can slice low priority data into a first frame, a plurality of intermediate frames, and a tail frame.

In the enveloping low priority frames, the first frame can be kept in the same frame format as an unsliced low priority frame. The transmitting device can apply MCRC in frame preemption instead of CRC as a checksum with 4 bytes in a tail, introduce a preamble in the plurality of intermediate frames and the tail frame after slicing, not introduce a destination address or an Ethernet type segment in the plurality of intermediate frames and the tail frame, and fill a sliced frame type in a byte after the preamble to mark as a certain subsequent frame of a slice.

In the combining sliced frames and the verifying the combination of sliced frames, for different low priority sliced first frames, a receiving device can determine correctness of the low priority sliced first frames via the byte after the preamble, and for different low priority sliced intermediate frames and tail frames, the receiving device can determine whether adjacent low priority slices arrives correctly and in order via the byte after the preamble.

For a deterministic transmission network, when transmitting a low priority frame on a line, and a high priority frame needs to be transmitted, it will be determined that whether the low priority frame can be preempted. When the low priority frame is a non-preemptible frame with a small byte, the high priority data frame can wait for the transmission of the low priority frame to be completed and then continue transmission. In this way, a delay can be small. When the low priority frame is a jumbo frame, the low priority frame needs to be sliced. The transmission of the sliced low priority frame will also affect the transmission of a next high priority frame, so that the low priority frame needs to be sliced into smaller data frames to reduce waiting time of the high priority frame.

Referring to FIG. 2, a scheduling algorithm of the frame preemption can ensure a prioritized transmission of the high priority data by interrupting the transmission of the low priority frames. Preemption actions can also produce different delays of transmission time, and the delay of transmission time of high priority data can be as follows: Delay of the high priority data=blocking of the same priority data+overhead of the frame preemption.

According to the above description, the preemption actions can still generate a great delay, which requires further overhead of the frame preemption. The sliced low priority frame can be marked by a new slice identification code to reduce a byte size of the sliced low priority frame. In this way, the overhead of the frame preemption can be reduced, thereby improving real-time performance of the high priority frame during transmission.

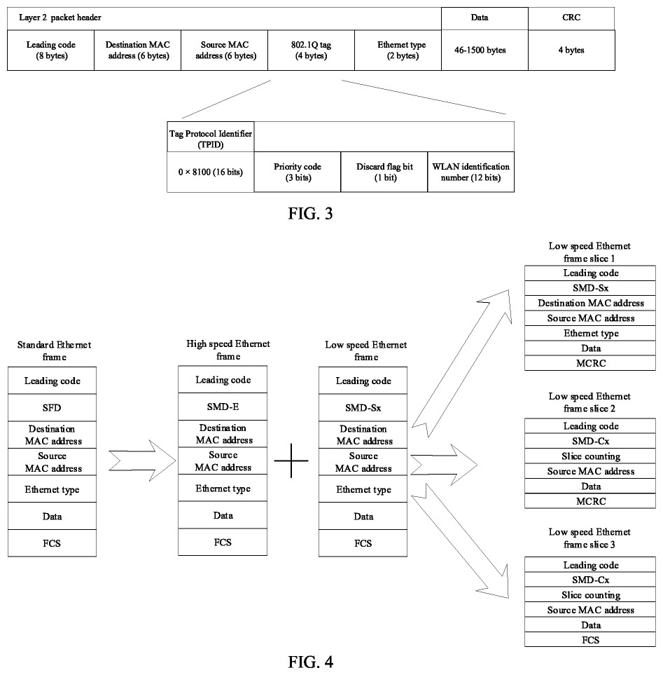

Referring to FIG. 3, a VLAN (Virtual Local Area Network) of an Ethernet frame defined in 802.1 Q can include a 7-bit preamble and a 1-byte SFD (start frame delimiter), and the Ethernet frame can also include a source MAC address, a destination MAC address, a 802.1 Q tag, an Ethernet type, data bytes, and a CRC (Cyclic Redundancy Check) checksum. When a priority code field in the 802.1 Q tag is 7, the priority of the Ethernet frame can be the highest and called the high priority frame, the transmission of which can interrupt the transmission of frames in other priorities.

In an actual transmission process, the low priority frame can mainly include four types: an unsliced low priority frame, a first frame that have been sliced, an intermediate frame that have been sliced, and a tail frame that have been sliced.

Difference between the sliced low priority frame and an original low priority frame can be in that the low priority frame can be both the first frame and the tail frame when the low priority frame is not sliced. Referring to FIG. 4, difference between an unsliced low priority frame and an unsliced high priority frame can be mainly in the last byte of the preamble, so as to distinguish the high priority frame and the low priority frame.

When the low priority frame is sliced into a plurality of slices, the low priority frame can be divided into the first frame, a plurality of intermediate frames, and the tail frame. The first frame is in the same frame format as the unsliced low priority frame, but since subsequent data and the CRC checksum of the first frame are cut out, the MCRC in frame preemption can be applied instead of CRC as a checksum with 4 bytes in the tail. The preamble can be introduced in the plurality of intermediate frames and the tail frame after slicing, and the destination address or the Ethernet type segment cannot be introduced in the plurality of intermediate frames and the tail frame. The sliced frame type can be filled in the byte after the preamble, the sliced frame type can be SMD-Cx, so as to mark as the certain subsequent frame of a slice, and a second byte after the preamble of the plurality of intermediate frames and the tail frame can include a slice counter segment. In addition, the plurality of intermediate frames can be the same as the first frame in that the MCRC needs to be added in the tail, and the tail frame can apply the original CRC. One or two segments after the preamble of the first frame, the plurality of intermediate frames, and the tail frame in the frame preemption need to be modified, and the segments can include a SMD segment and a MCRC segment. The specific coding values of the SMD segment can be shown in Table 1 below.

TABLE 1
A coding method of slicing Ethernet frames

| | frame | |
|---|---|---|
| frame type | serial numbers | SMD code |
| SMD-E | NA | 0xD5 |
| high priority frames | | |
| SMD-Sx | 1 | 0x4C |
| low priority sliced first | 2 | 0x7F |
| frames and slice counting | 3 | 0xB3 |
| SMD-Cx | 1 | 0x52 |
| low priority sliced | 2 | 0x9E |
| intermediate frames and | 3 | 0x2A |
| tail frames | | |

SMD-Sx and SMD-Cx are applied to the first frame and subsequent frames in the low priority frames, respectively. Since a frame preemption function requires that the frame can be correctly restored at a receiving end after the frame is sliced at a sending end, the SMD-Sx and SMD-Cx can provide 3 different values for slice counting, respectively. The slice counting can provide 3 frame serial numbers to ensure that the currently received sliced frame are consecutive. The specific steps are as follows.

When a SMD value of the SMD-CX is received, a data receiving process on the receiving end can include the following determinations.
a) whether an ongoing packet is preempted;
b) the number of frames indicated by the SMD value can match with that of the ongoing packet;
c) a slice counting value can indicate the number of slices of a low priority frame.

For different SMD-Sxs, the receiving device can determine correctness of the low priority sliced first frames via a specific value, and for different SMD-Cxs, the receiving device can determine whether adjacent low priority slices arrive correctly and in order via a specific value. The receiving device can record the slice counting value of the last received frame to compare with that of a received frame next time. The receiving device can determine that the frame was transmitted incorrectly after the received frames do not meet consecutive slice counting, thereby discarding the received frames. The receiving device can discard slices that have been buffered and slices that have not yet been received.

A jumbo frame can be sliced into a plurality of short byte data by a slicing method mentioned above, effectively reducing overhead time of frame preemption generated in the transmission process of the high priority frame, and effectively improving transmission capacity of data flow with wide bandwidth in the network. In addition, high real-time performance of discrete data during transmission can be met, and production efficiency of the device can be improved.

The present disclosure provides the deterministic data transmission device and method for the compatibility network, which can solve a problem of high delay during data transmission caused by a conventional preemption technology. For high traffic networks and an increasing scale of an industrial Internet system, a new scheduling algorithm can be proposed by adopting a new data integration method. A new combination method of the low priority frame can be provided to reduce waiting time of the high priority frame, to ensure determinacy during transmission and a transmission delay of a nanosecond level. Furthermore, a data transmission device compatible with conventional Ethernet data frames and high real-time Ethernet data frames can be adopted, so that uniformity of transmission devices and interoperability between devices can be ensured, thus effectively improving industrial production efficiency and establishing a flexible production method.

The technical features of the above-described embodiments may be combined in any combination. For the sake of brevity of description, not all possible combinations of the technical features in the above embodiments are described. However, as long as there is no contradiction between the combinations of these technical features, all should be considered as within the scope of this disclosure.

The above-described embodiments are merely illustrative of several embodiments of the present disclosure, and the description thereof is relatively specific and detailed, but is not to be construed as limiting the scope of the disclosure. It should be noted that a number of variations and modifications may be made by those skilled in the art without departing from the spirit and scope of the disclosure, and these variations and modifications belong to the scope of the claimed disclosure. Therefore, the scope of the disclosure should be determined by the appended claims.

We claim:

1. A deterministic data transmission device for a compatibility network, comprising a data link layer and a physical layer of an open system interconnection,
wherein the data link layer comprises a support module of preemption function of a MAC client, a MAC control module, and a MAC merge module;
the physical layer comprises a coordination sublayer and a port physical layer, the support module of preemption function of the MAC client is connected to the MAC control module, and the MAC merge module is connected to the coordination sublayer; and
the port physical layer comprises a physical transport medium connected to the coordination sublayer.

2. The deterministic data transmission device for the compatibility network of claim 1, wherein when data is sent, the data link layer is configured to identify the preemption function of the MAC client, and the MAC control module is configured to allocate high real-time demand data and non-real-time demand data to two channels, respectively, and transmit the high real-time demand data and non-real-time demand data via the physical layer; and
when data is received, the physical layer is configured to transmit the data to the data link layer, the MAC merge module of the data link layer is configured to identify preempted data and merge the preempted data, and the MAC control module is configured to allocate high real-time demand data and non-real-time demand data of merged data to a higher-level open system interconnection, respectively.

3. The deterministic data transmission device for the compatibility network of claim 1, wherein the support module of preemption function of the MAC client is configured to identify whether a data slicing function of a local port is turned on,
if yes, it indicates that a transmission of high priority data is supported to interrupt a transmission of low priority data, the transmission of the low priority data is suspended, and the low priority data is sliced to wait for the transmission of the high priority data to be completed and then continue transmission; and
if no, it indicates that a transmission of sliced data is not supported and a data transmission is performed according to QoS mechanism.

4. The deterministic data transmission device for the compatibility network of claim 1, wherein the MAC merge module is configured to reorganize received sliced data with the support of the preemption function, and to recover data at a receiving port for the low priority data, a transmission of which is interrupted.

5. The deterministic data transmission device for the compatibility network of claim 1, wherein the MAC control module is connected to the MAC merge module, and the MAC control module comprises a pMAC channel and an eMAC channel,
high priority data is transmitted in the eMAC channel, data that is capable to be preempted is transmitted in the pMAC channel; and
data without priority order requirements is transmitted in the pMAC channel or the eMAC channel.

6. A deterministic data transmission method for a compatibility network, comprising slicing of low priority data, enveloping low priority frames, combining sliced frames, and verifying a combination of sliced frames,
wherein in the slicing of low priority data, a transmitting device slicing low priority data into a first frame, a plurality of intermediate frames, and a tail frame;
in the enveloping low priority frames, keeping the first frame in the same frame format as an unsliced low priority frame, the transmitting device applying MCRC in frame preemption instead of CRC as a checksum with 4 bytes in a tail, introducing a preamble in the plurality of intermediate frames and the tail frame after slicing, not introducing a destination address or an Ethernet type segment in the plurality of intermediate frames and the tail frame, and filling a sliced frame type in a byte after the preamble to mark as a certain subsequent frame of a slice; and
in the combining sliced frames and the verifying the combination of sliced frames, for different low priority sliced first frames, a receiving device determining correctness of the low priority sliced first frames via the byte after the preamble; for different low priority sliced intermediate frames and tail frames, the receiving device determining whether adjacent low priority slices arrive correctly and in order via the byte after the preamble.

7. The deterministic data transmission method for the compatibility network of claim 6, wherein a second byte after the preamble of the plurality of intermediate frames and the tail frame comprises a slice counter segment.

8. The deterministic data transmission method for the compatibility network of claim 6, wherein the method further comprises modifying one or two segments after the preamble of the first frame, the plurality of intermediate frames, and the tail frame in the frame preemption, p1 wherein the segments comprise a SMD segment and a MCRC segment; SMD-Sx and SMD-Cx are applied to the first frame and subsequent frames in low priority frames, respectively, and the SMD-Sx and SMD-Cx provide 3 different values for slice counting, respectively.

9. The deterministic data transmission method for the compatibility network of claim 7, wherein the method further comprises:
the receiving device recording a slice counting value of the last received frame to compare with that of a received frame next time;
the receiving device determining that the frame was transmitted in error after the received frame does not meet consecutive slice counting, thereby discarding the received frame; and
the receiving device discarding slices that have been buffered and slices that have not yet been received.

10. The deterministic data transmission method for the compatibility network of claim 8, wherein MCRC is introduced into tails of the plurality of intermediate frames, and the MCRC is configured to check frame bytes of sliced data frames.
